(19) United States
(12) Patent Application Publication
(10) Pub. No.: US 2015/0307383 A1
(43) Pub. Date: Oct. 29, 2015

(54) METAL SECTOR FOR BOTTOM OF GLASS MELTING FURNACE, AND GLASS MELTING FURNACE

(71) Applicant: KOREA HYDRO & NUCLEAR POWER CO., LTD., Gyeongsangbuk-do (KR)

(72) Inventors: Deuk Man KIM, Daejeon (KR); Sang Woo LEE, Daejeon (KR); Cheon Woo KIM, Daejeon (KR)

(73) Assignee: KOREA HYDRO & NUCLEAR POWER CO., LTD., Gyeongsangbuk-do (KR)

(21) Appl. No.: 14/443,766

(22) PCT Filed: May 16, 2013
(86) PCT No.: PCT/KR2013/004369

§ 371 Date: May 19, 2015

(30) Foreign Application Priority Data
Nov. 19, 2012 (KR) 10-2012-0130940

(51) Int. Cl. C03B 5/02; C03B 5/26; H05B 6/28; C03B 5/42

(52) U.S. Cl. CPC C03B 5/021; C03B 5/42; C03B 5/26; H05B 6/28; F27B 2014/066

(57) ABSTRACT

A plurality of metal sectors separately arranged so as to form a bottom of a glass melting furnace. The metal sectors include an upper surface made from a bottom surface of the glass melting furnace, a lower surface opposite to the upper surface, and a plurality of lateral surfaces coming in contact with the upper surface and the lower surface. An electrical arc suppression structure is provided at a part or an entire part of a corner in which the upper surface or the lower surface comes in contact with each lateral surface. The electrical arc suppression structure is a rounded corner or an insulation coating layer. The electrical arc suppression structure enables stable operation of the glass melting furnace.

### TECHNICAL FIELD

The present invention relates to the field of glass melting furnaces. More particularly, the present invention relates to a metal sector structure for the bottom of a glass melting furnace, and a glass melting furnace including the same.

### Background Art

Vitrification technology is widely used for the treatment of radioactive waste. The vitrification of radioactive waste is the technology of trapping radionuclides of radioactive waste in a matrix of glass, enabling the radioactive waste to be treated very reliably.

For vitrification processing, radioactive waste and glass are inputted into and melted in a glass melting furnace. When the resulting melt is solidified, a vitrified solid is produced.

In general, an induction heating melting furnace is used for the vitrification of the radioactive waste.

Korean Laid-Open Patent Publication No. 10-2001-0101107 disclosed a method of vitrifying radioactive waste by induction heating and a melting furnace.

The induction heating melting furnace of the related art has the problem of electrical arcs induced by metal components. In particular, electrical arcs frequently occur from metal sectors that constitute the bottom of the furnace.

### RELATED ART DOCUMENT

### Patent Document

Patent Document 1: Korean Laid-Open Patent Publication No. 10-2001-0101107

### DISCLOSURE

### Technical Problem

Accordingly, the present invention has been made keeping in mind the above problems occurring in the prior art, and an object of the present invention is to provide a metal sector for the bottom of a glass melting furnace, in which rounded corners of the metal sector serve to suppress electrical arcs.

Also provided is a glass melting furnace including the improved metal sector.

### Technical Solution

In order to accomplish the above object(s), the present invention provides a metal sector for the bottom of a glass melting furnace. The metal sector includes: a top surface forming the bottom surface of the glass melting furnace; a bottom surface facing the top surface; and a plurality of side surfaces adjoining the top surface and the bottom surface. At least one corner portion of corner portions where the top surface or the bottom surface adjoins the plurality of side surfaces has an electrical arc suppression structure. A plurality of the metal sectors separated from each other forms the bottom of the glass melting furnace.

The electrical arc suppression structure may be a rounded corner.

The electrical arc suppression structure may be an insulation coating layer. The insulation coating layer may be formed by plasma coating. In addition, the insulation coating layer may be formed on a rounded corner.

The glass melting furnace may have an outlet in the bottom through which melt is discharged. The plurality of metal sectors may be arranged in a circular direction around the outlet.

An insulator may be disposed between the plurality of metal sectors.

Each of the plurality of metal sectors may include the electrical arc suppression structure on at least one upper corner portion adjoining another metal sector of the plurality of metal sectors in the circular direction in which the plurality of metal sectors is arranged.

Also provided is a glass melting furnace including the above-described metal sector according to the invention, the metal sector being disposed on a bottom surface of the glass melting furnace.

### Advantageous Effects

According to the present invention, electrical arcs are suppressed, thereby enabling a reliable operation of the glass melting furnace. In particular, since the corner portions of the plurality of metal sectors forming the bottom of the melting furnace are formed as rounded surfaces, it is possible to better prevent electrical arcs. Furthermore, it is possible to further prevent electrical arcs by forming the insulation coating layer on the corner portions of the metal sectors by plasma coating.

### DESCRIPTION OF DRAWINGS

FIG. 1 is a view schematically illustrating a glass melting furnace in which metal sectors according to the invention are applied;

FIG. 2 is a view illustrating the bottom of a glass melting furnace to which the metal sectors according to the invention are applied;

FIG. 3 and FIG. 4 are views illustrating a metal sector for the bottom of a glass melting furnace according to the invention.

### DESCRIPTION OF THE REFERENCE NUMERALS IN THE DRAWINGS

| | |
|---|---|
| 10: glass melting furnace | 100: sidewall |
| 200: bottom | 210: metal sector |
| 211: top surface | 212: bottom surface |
| 213: side surface | 214: rounded corner |
| 220: insulator | 230: outlet |
| 2110: insulation coating layer | |

### Best Mode

Reference will now be made in greater detail to an exemplary embodiment of the present invention in conjunction with the accompanying drawings. In the following description of the present invention, detailed descriptions of known functions and components incorporated herein will be omitted in the case that the subject matter of the present invention is rendered unclear.

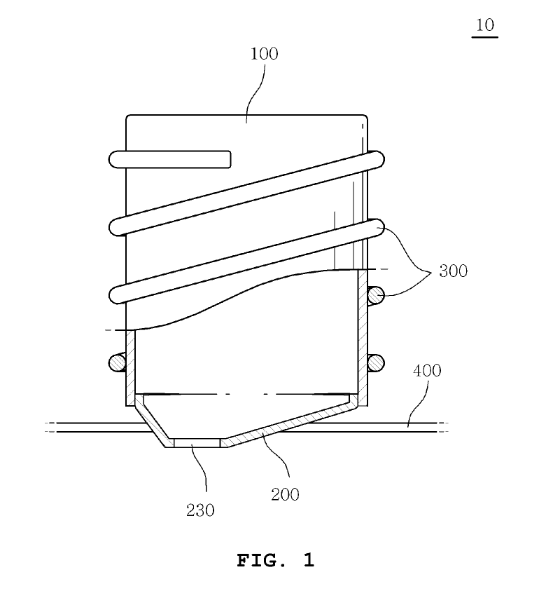

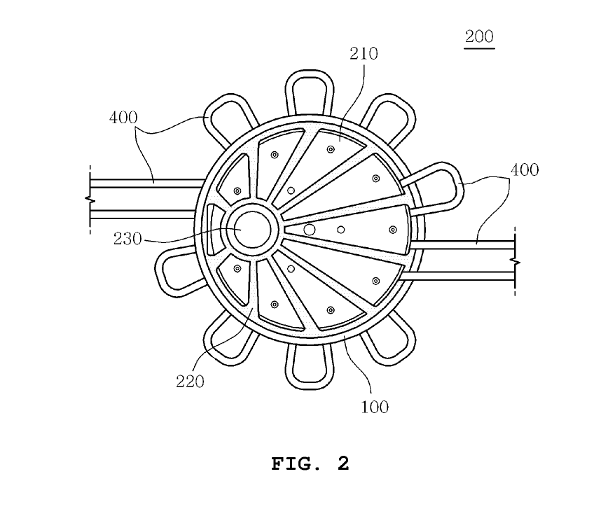

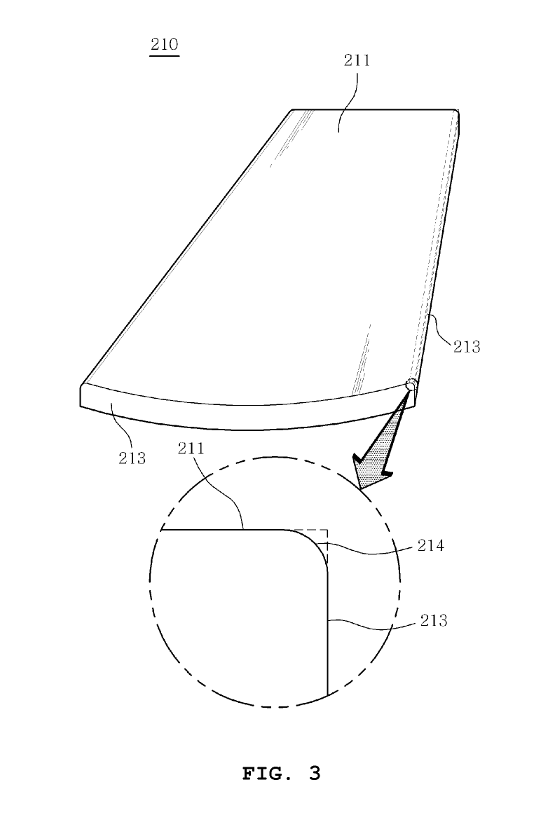

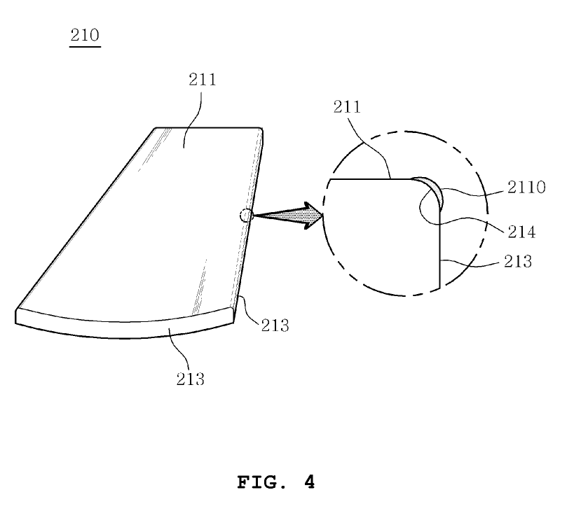

FIG. 1 is a view schematically illustrating a glass melting furnace to which metal sectors according to the invention are applied, FIG. 2 is a view illustrating the bottom of a glass melting furnace to which the metal sectors according to the invention are applied, and FIG. 3 and FIG. 4 are views illustrating a metal sector for the bottom of a glass melting furnace according to the invention.

As illustrated in FIG. 1, a glass melting furnace 10 to which metal sectors according to the invention are employed includes a melting furnace sidewall 100, a bottom 200, an induction coil 300, and a cooling part 400.

The glass melting furnace 10 is substantially in the shape of a cylinder. Within the glass melting furnace 10, glass and radioactive waste are melted.

The body of the glass melting furnace 10 includes the sidewall 100 and the bottom 200.

Each of the sidewall 100 and the bottom 200 includes a plurality of sectors formed of a metal material. An insulator is disposed between the metal sectors.

The bottom 200 has an outlet 230 through which melt is discharged.

FIG. 2 is a top plan view illustrating the bottom of the glass melting furnace in which metal sectors according to the invention are employed.

As illustrated in this figure, the bottom 200 of the glass melting furnace 10 includes a plurality of metal sectors 210, an insulator 220 disposed between the metal sectors, and an outlet 230.

As apparent from FIG. 1, the bottom 200 has an inclined structure, with the outlet 230 being disposed at a relatively low position, such that melt can be spontaneously discharged through the outlet 230. Although the position of the outlet 230 is at the center, the outlet 230 may be disposed in a biased position.

Accordingly, the plurality of metal sectors 210 according to the invention for the bottom are arranged around the outlet 230 to form a funnel shape having a wider upper part and a narrower lower part. Consequently, the respective metal sectors 210 are in a trapezoidal or fan shape having a variety of sizes.

As illustrated in FIG. 3 and FIG. 4, each of the metal sectors 210 has a top surface 211, a bottom surface, and a plurality of side surfaces 213.

The insulator situated between the plurality of metal sectors 210 is intended to prevent electrical arcs. Since the plurality of metal sectors 210 has a predetermined thickness, corners are in an angled shape, which may induce electrical arcs, thereby damaging the metal sectors.

As illustrated in these figures, the corners of the metal sectors 210 for the bottom of a glass melting furnace according to the invention are rounded. Specifically, the corners at which the top surface 211 and the side surface 213 of each metal sector 210 form rounded corners 241.

More specifically, the metal sectors 210 for the bottom of a glass melting furnace according to the invention are arranged in the circular direction around the outlet 230. At least the corner of each metal sector 210 forms the rounded corner 214. The rounded corner 214 may be formed by rounding the angled corner or may be previously fabricated as a rounded corner.

Consequently, the metal sectors 210 for the bottom of a glass melting furnace according to the invention have the rounded corners, the configuration of which can further suppress electrical arcs. This consequently allows melt to be rapidly discharged, whereby a reliable operation becomes possible.

Alternatively, the metal sectors 210 for the bottom of a glass melting furnace according to the invention may have an insulation coating layer 2110. It is preferable that the insulating coating layer be formed by plasma coating.

Although the insulation coating layer 2100 may be formed without rounding the corner portions, it is preferable that the corner portions are processed to have rounded corners before the insulation coating layer 2100 is formed thereon by plasma.

The corner portions on which the insulation coating layer 2110 is formed are the upper corner portions of the metal sectors 210 as above. More specifically, the corners are the portions of the metal sectors 210 arranged in the circular direction around the outlet 230 to adjoin the other metal sectors 210 in the direction in which the metal sectors 210 are arranged.

In addition, it is possible to prevent electrical arcs induced by the insulator, i.e. a component of the metal sector, from causing electrical damages.

Although the specific embodiments of the present invention have been described, a person skilled in the art will appreciate that various modifications, additions and substitutions are possible, without departing from the scope and spirit of the present invention.

1. A metal sector for a bottom of a glass melting furnace, the metal sector comprising:
a top surface forming a bottom surface of the glass melting furnace;
a bottom surface facing the top surface; and
a plurality of side surfaces adjoining the top surface and the bottom surface,
wherein at least one corner portion of corner portions where the top surface or the bottom surface adjoins the plurality of side surfaces has an electrical arc suppression structure,
wherein a plurality of the metal sectors separated from each other forms the bottom of the glass melting furnace.

2. The metal sector according to claim 1, wherein the electrical arc suppression structure comprises a rounded corner.

3. The metal sector according to claim 1, wherein the electrical arc suppression structure comprises an insulation coating layer.

4. The metal sector according to claim 3, wherein the insulation coating layer is formed by plasma coating.

5. The metal sector according to claim 3, wherein the insulation coating layer is formed on a rounded corner.

6. The metal sector according to claim 1, wherein the glass melting furnace comprises an outlet in the bottom through which melt is discharged, and the plurality of metal sectors is arranged in a circular direction around the outlet.

7. The metal sector according to claim 6, wherein an insulator is disposed between the plurality of metal sectors.

8. The metal sector according to claim 7, wherein each of the plurality of metal sectors comprises the electrical arc suppression structure on at least one upper corner portion adjoining another metal sector of the plurality of metal sectors in the circular direction in which the plurality of metal sectors is arranged.

9. A glass melting furnace comprising the metal sector as claimed in claim 1, the metal sector being disposed on a bottom surface of the glass melting furnace.

10. A glass melting furnace comprising the metal sector as claimed in claim 2, the metal sector being disposed on a bottom surface of the glass melting furnace.

11. A glass melting furnace comprising the metal sector as claimed in claim 3, the metal sector being disposed on a bottom surface of the glass melting furnace.

12. A glass melting furnace comprising the metal sector as claimed in claim 4, the metal sector being disposed on a bottom surface of the glass melting furnace.

13. A glass melting furnace comprising the metal sector as claimed in claim 5, the metal sector being disposed on a bottom surface of the glass melting furnace.

14. A glass melting furnace comprising the metal sector as claimed in claim 6, the metal sector being disposed on a bottom surface of the glass melting furnace.

15. A glass melting furnace comprising the metal sector as claimed in claim 7, the metal sector being disposed on a bottom surface of the glass melting furnace.

16. A glass melting furnace comprising the metal sector as claimed in claim 8, the metal sector being disposed on a bottom surface of the glass melting furnace.
